(19) United States
(12) Patent Application Publication
(10) Pub. No.: US 2008/0072759 A1
(43) Pub. Date: Mar. 27, 2008

(54) Filter device

(75) Inventors: Miroslav Podhorsky, Ratingen (DE); Thomas Riepe, Heiligenhaus (DE); Timo Seppaelae, Helsinki (FI)

Correspondence Address: BAKER & HOSTETLER LLP, WASHINGTON SQUARE, SUITE 1100, 1050 CONNECTICUT AVE. N.W., WASHINGTON, DC, 20036-5304, US

(73) Assignee: BALCKE-DURR Gmbh

(21) Appl. No.: 11/527,717

(22) Filed: Sep. 27, 2006

(30) Foreign Application Priority Data
Sep. 27, 2006 (EP) 05021046.7

(51) Int. Cl. B03C 3/76; B03C 3/78

(52) U.S. Cl. 96/32; 96/97; 96/98; 96/100; 55/DIG. 38; 96/44

(57) ABSTRACT

The present invention relates to a filter device for separating particles from a gaseous fluid sucked in by a gas turbine, the filter device having a vertically situated tubular electric filter. Maintenance work on a gas turbine may thus be significantly reduced and, in addition, a higher gas turbine output may be achieved due to low pressure loss of the tubular electric filter.

### CROSS-REFERENCE TO RELATED APPLICATIONS

This application claims priority of European Patent Application No. 05021046.7, filed Sep. 27, 2005, the entire contents of which are incorporated herein by reference.

### FIELD OF THE INVENTION

The present invention relates to a filter device for separating particles from a gaseous fluid sucked in by a gas turbine and a gas turbine having such a filter device.

### BACKGROUND OF THE INVENTION

In a gas turbine, a compressor sucks in air from the environment, compresses it, and conducts it to a combustion chamber of the gas turbine. The air is combusted there together with a supplied fuel, through which hot combustion gases arise. The combustion gases flow at high velocity into a turbine, which is thus driven.

When sucking in the air from the environment of the gas turbine compressor, it is unavoidable that dirt particles are also introduced into the compressor. The dirt particles may have grains of sand, insects, pollen, dust of different chemical composition, etc. In the compressor, they hit rotating parts, due to which undesired reactions may result. These include erosion or corrosion of compressor blades, deposits on the compressor blades and other parts in the interior of the compressor, or agglomerations and chemical reactions of the supplied foreign bodies with one another.

In order to reduce the effects of reactions of this type, the intake air is typically filtered using a textile filter before entering the compressor. Very effective filtering may be achieved using the currently available textile filters, so that hardly any dirt particles may still penetrate into the interior of a compressor. However, if filters of this type are used, the basic problem exists that increasing filter action is accompanied by a pressure loss, so that a compromise must always be reached between filter efficiency and efficiency of the gas turbine. In addition, it has been shown that in the event of damp environmental air, for example, because of fog, the dirt particles retained in the filter become damp, clump together, and the air permeability and efficiency of the filter are thus restricted, because of which an additional pressure loss in the compressor is unavoidable. In particular at temperatures below 0° C., the operation of a textile filter may become problematic, since ice forms at a damp surface of the filter, a flow passage is thus significantly impaired, and a gas turbine is only still operable in a restricted way. In order to avoid these effects, the textile filters used are typically regularly replaced by new, clean filters, the associated compressor, including the compressor blades, being cleaned multiple times a year to achieve a long service life of the gas turbine. Since the gas turbine, which is typically in operation uninterruptedly, must be turned off for this purpose and power generation by the gas turbine is thus interrupted, maintenance measures of this type are complex and costly.

### SUMMARY OF THE INVENTION

The present invention is therefore based on the object of specifying a filter device of the above-mentioned type which has a low pressure loss between the intake and outlet sides of the filter device with a high filter action, so that a high gas turbine output is thus achievable, this being possible both with dry and also damp environmental air. In addition, time-consuming maintenance and cleaning of the filter device are no longer to be necessary.

This object is achieved in that the filter device for separating particles from a gaseous fluid sucked in by a gas turbine has a vertically situated tubular electric filter. In such a filter, dirt particles in the gaseous fluid are electrically charged and transported by the effect of electrical forces to an electrode, on which they are deposited. Since the gaseous fluid no longer has to flow through a mesh of a textile filter, this filtering is coupled with a low pressure loss between intake and outlet sides of the filter device, so that even large gaseous fluid streams may be filtered efficiently. The charging of dirt particles is possible even with damp gaseous fluid, so that a dry fluid may be achieved at the outlet side of the filter. The frequency of maintenance work to clean compressor blades, inter alia, is thus significantly reduced, and the erosion and corrosion of compressor blades is lessened. Due to the low pressure loss, a compressor may be dimensioned smaller and a greater gas turbine output may be achieved.

In a preferred embodiment of the present invention, the tubular electric filter of the filter device has needle-shaped discharge electrodes for ionizing the particles in the gaseous fluid, which generate overlapping ion jets. A strong turbulence of the ion jets may thus be generated, through which the dirt particles in the gaseous fluid may be braked and conveyed effectively to an electrode provided for the deposition. A high deposition rate of the dirt particles may thus be achieved.

It is advantageous if a voltage of greater than 130 kV is applied between a positive electrode and a negative electrode of the tubular electric filter. A relatively large distance between the electrodes may thus be achieved, so that the pressure loss when flowing through the filter is even lower. In addition, larger tolerances for a deposited quantity of dust on a precipitating electrode may be permitted through the greater spacing of the electrodes. A time interval between individual cycles for cleaning a filter of this type may thus be increased. Furthermore, an even higher deposition rate and thus a very efficient filter effect are made possible by a voltage this high.

The tubular electric filter may have a filter cell having a precipitating electrode implemented in a honeycomb shape for the deposition of the dirt particles, the precipitating electrode being situated around the discharge electrodes. The honeycomb structure allows a self-supporting construction of the filter device, so that a light construction is achievable. This reduces the production costs of the filter device according to the present invention.

The filter device is preferably provided with a tubular electric filter which has 1, 3, 4, 7, 10, 16, 25, 36, 45, 55, 65, or 95 filter cells. The filter cells are situated in a parallel circuit, so that through a modular construction of the filter device of this type, very small to very large volume flows may be filtered efficiently.

The filter device according to the present invention is preferably implemented in such a way that dry or wet cleaning of the electrodes may be performed in the tubular electric filter. Suitable cleaning of the electrodes may thus be performed depending on the availability of cleaning media. If dry cleaning of an electrode is provided, this cleaning may preferably be performed according to the present invention by mechanically induced vibration of the electrodes. This may be performed, for example, in that impact tools hit the electrodes regularly, through which the dust is detached from the electrode faces and falls off. If the operating voltage is briefly lowered during the striking, the cleaning may be improved. In wet cleaning, the electrodes are sprayed with water, for example, and the resulting slurry is flushed out.

In a further embodiment of the present invention, the filter device has at least one additional filter, which is connected downstream from the tubular electric filter. This may be a plate electric filter having relatively narrow channels, which is provided for dry gaseous fluid. The additional filter assumes a “monitoring function” so that in the event of gaseous fluid which is possibly not filtered well by the tubular electric filter, additional security in regard to low introduction of dirt particles into the compressor exists.

A textile filter may also be provided as an additional filter. This is advantageous since the contamination of the textile filter may be reduced to a minimum by the upstream tubular electric filter, so that the difficulties known up to this point, such as frequent maintenance work, no longer occur in a textile filter downstream of the tubular electric filter. A damp gaseous fluid is already freed of moisture enough after passing the tubular electric filter that clumping or clogging of filter mesh no longer occurs in the textile filter. This is also advantageous for operation of the filter in winter, since the dirt particles may no longer freeze on the textile filter and a passage of gaseous fluid is no longer blocked. The textile filter is additionally advantageous since it is operable without the supply of electrical power, so that if electrical power is not provided, sufficient filtering of the air sucked in by the compressor is still achievable for a limited time.

The present invention also relates to a gas turbine having a compressor, a combustion chamber, and a turbine, the gas turbine having a filter device as was described above.

### BRIEF DESCRIPTION OF THE DRAWINGS

In the following, the present invention is described further on the basis of exemplary embodiments illustrated in the drawing.

FIG. 1: shows a schematic illustration of a first turbine having a filter device according to the present invention;

FIG. 2: shows a schematic illustration of a second gas turbine having a filter device according to the present invention;

FIG. 3: shows a top view of a first embodiment of the filter device according to the present invention having a vertical tubular electric filter, and

FIG. 4: shows a top view of a second embodiment of the filter device according to the present invention having multiple filter cells.

### DETAILED DESCRIPTION

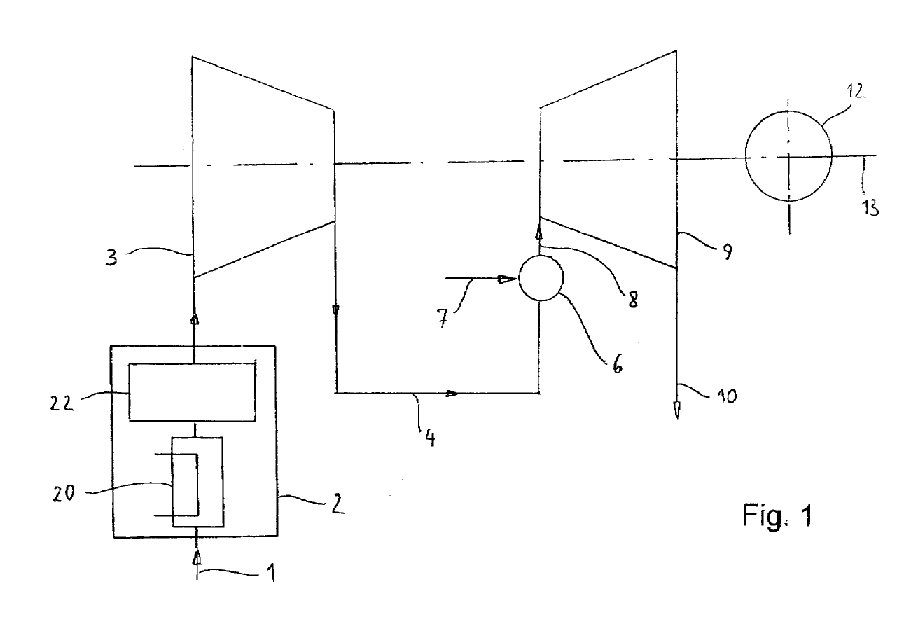

FIG. 1 schematically shows a gas turbine 100. Air 1 is sucked in from the outside by a compressor 3 and passes a filter device 2. In this embodiment, the filter device 2 has a tubular electric filter 20 and a downstream textile filter 22, which are only schematically shown in FIG. 1. The tubular electric filter is provided for the purpose of achieving high filtering, even of a damp gaseous fluid such as air, in a first filter stage. Dried air is thus supplied to the downstream textile filter, so that clumping of dirt particles no longer occurs and good air passage is provided. The air thus filtered enters the compressor 3 and is compressed there until it exits again at its outlet as compressed air 4. It is conducted there to a combustion chamber 5, where it is combusted together with a supplied fuel 7. Combustion gases 8 result, which are conducted to a downstream turbine 9 and drive the turbine. The flow energy of the combustion gases 8 is partially converted into mechanical energy by driving the compressor 3 and a generator 12. For this purpose, the compressor 3 and the turbine 9, as well as the generator 12, are mounted on a shared shaft 13. Finally, the combustion gas 8 exits the turbine 9 as hot exhaust gas 10 after passing the turbine 9.

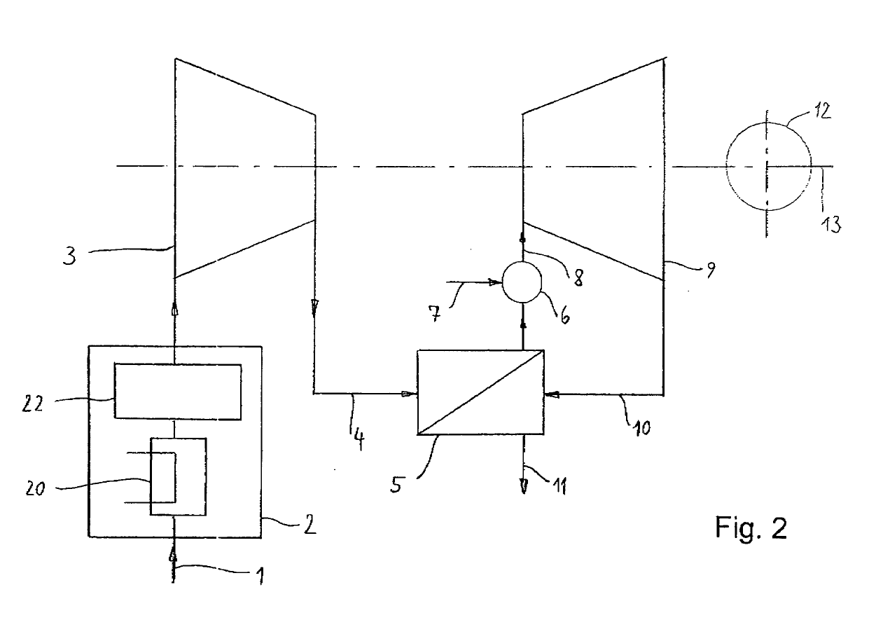

The efficiency of a gas turbine may be increased if the heat of the hot exhaust gas 10 is used. This is performed, for example, by supplying the hot exhaust gas to a recuperator 5 (heat exchanger), which preheats the compressed air 4 before it reaches the combustion chamber 8, see FIG. 2. The quantity of the supplied fuel 7 may thus be reduced, so that less energy is required for operating the gas turbine. Less hot exhaust gas 11 subsequently exits from the recuperator 5.

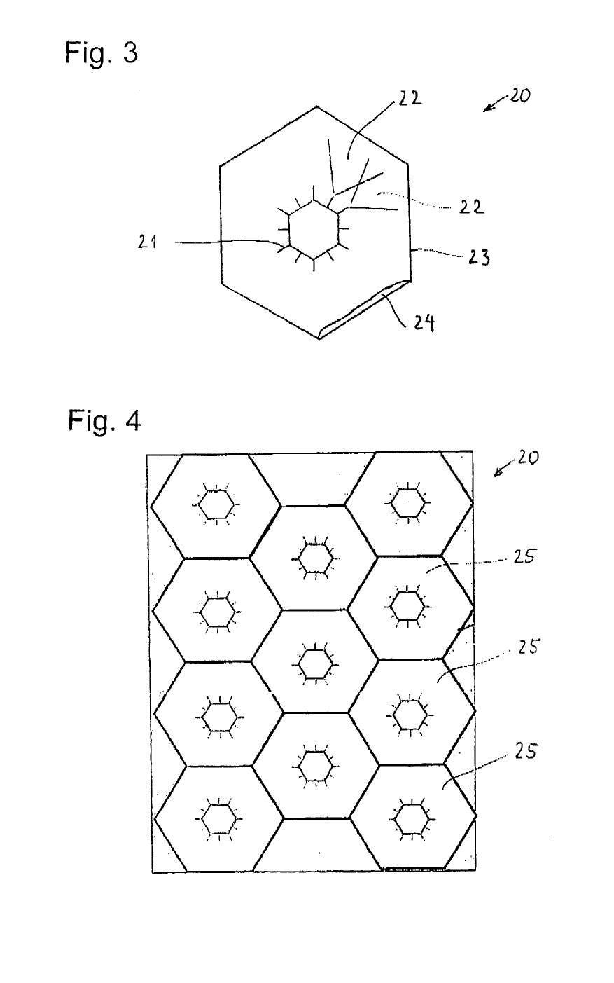

A top view of a tubular electric filter 20, which is used in the filter device according to the present invention, is shown in FIG. 3. The tubular electric filter 20 has discharge electrodes 21, which project in needle shapes in the direction toward the precipitating electrode 23 enclosing them. The discharge electrodes are polarized cathodically, so that when a voltage is applied, electrons are emitted by the discharge electrodes. The electrons experience such a strong acceleration that from a specific voltage, ionization of the gaseous fluid which encloses the discharge electrodes and is to be filtered occurs. This ionization occurs far below the breakdown voltage.

On the way from the discharge electrodes to the precipitating electrode, the free electrons hit neutral gas molecules, so that gas ions and further electrons arise through impact ionization. An electron avalanche thus forms, which moves toward the precipitating electrode. If the discharge electrodes are sufficiently close to one another, the gas ion jets 22 are superimposed on one another, as shown in FIG. 3. The gas ions hit the precipitating electrode and release further electrons upon incidence there. In addition, the gas ions accumulate on dust particles and thus charge them. Under the effect of the electrical field between electrodes, the charged dust particles are transported transversely to the flow direction of the fluid toward the precipitating electrode, where they deliver their charges and accumulate on its surface because of adhesive forces, so that a deposited dust layer 24 is formed (only a part of the precipitating electrode surface having a deposited layer 24 is shown in FIG. 3). The entire flow which moves from the discharge electrodes toward the precipitating electrode is referred to as an electrical wind, this wind comprising negatively charged particles, neutral particles, electrons, and ions. The achievable current strength is a function, inter alia, of the dust content of the gas to be purified and the already existing dust deposits on the electrodes.

The precipitating electrode is to be implemented so that the interval between the electrodes is approximately equal to achieve a nearly constant electrical field between a discharge electrode and an associated precipitating electrode.

In the embodiment of the tubular electric filter shown in FIG. 3, the precipitating electrode is implemented as honeycombed and/or as a hexagonal tube. This is advantageous in regard to joining multiple filter cells 25 together in particular, see FIG. 4. A self-supporting structure of the filter device may thus be achieved without intermediate space between the individual cells, which requires relatively little material and is nonetheless stable. Through the honeycomb structure, it is easily possible to achieve a larger or smaller passage area for the fluid to be filtered by combining a desired number of filter cells with one another.

1. A filter device for separating particles from a gaseous fluid sucked in by a gas turbine, comprising:
a vertically situated tubular electric filter.

2. The filter device according to claim 1,
wherein the tubular electric filter has needle-shaped discharge electrodes, which generate overlapping ion jets, for ionizing the particles in the gaseous fluid.

3. The filter device according to claim 1,
wherein a voltage of greater than 130 kV is applied between a positive electrode and a negative electrode of the tubular electric filter.

4. The filter device according to claims 2,
wherein the tubular electric filter has a filter cell having a precipitating electrode implemented in a honeycomb shape, which is situated around the discharge electrodes.

5. The filter device according to claim 4, wherein the tubular electric filter has 1, 3, 4, 7, 10, 16, 25, 36, 45, 55, 65, or 95 filter cells.

6. The filter device according to claim 4,
wherein dry or wet cleaning of the electrodes may be performed in the tubular electric filter.

7. The filter device according to claim 6,
wherein dry cleaning of the electrodes may be performed through mechanically induced vibration of the electrodes.

8. The filter device according to claim 1,
wherein the filter device has at least one additional filter, which is connected downstream from the tubular electric filter.

9. The filter device according to claim 8,
wherein a plate electric filter is provided as the additional filter.

10. The filter device according to claims 8,
wherein a textile filter is provided as the additional filter.

11. A gas turbine having a compressor, a combustion chamber, and a turbine, wherein the gas turbine has a filter device according to claim 1.

12. The filter device according to claim 2,
wherein a voltage of greater than 130 kV is applied between a positive electrode and a negative electrode of the tubular electric filter.

13. The filter device according to claim 3,
wherein the tubular electric filter has a filter cell having a precipitating electrode implemented in a honeycomb shape, which is situated around the discharge electrodes.

14. The filter device according to claim 5,
wherein dry or wet cleaning of the electrodes may be performed in the tubular electric filter.

15. The filter device according to claim 9,
wherein a textile filter is provided as the additional filter.
